(19) United States
(12) Patent Application Publication
(10) Pub. No.: US 2026/0298313 A1
(43) Pub. Date: Oct. 1, 2026

(54) ENERGY GUIDE CHAIN COMPRISING INNER AND OUTER PLATES WITH INTEGRATED LIMIT STOP SYSTEM

(71) Applicant: IGUS GMBH, Köln (DE)

(72) Inventors: Stefan STRACK, Königswinter (DE); Christian ZIEGLER, Niederkassel (DE)

(21) Appl. No.: 19/475,823

(22) PCT Filed: Apr. 17, 2024
(86) PCT No.: PCT/EP2024/060460

§ 371 Date: Oct. 16, 2025

(30) Foreign Application Priority Data
Apr. 17, 2023 (DE) 20 2023 101 968.4

(51) Int. Cl. F16G 13/16

(52) U.S. Cl. CPC F16G 13/16

(57) ABSTRACT

The proposed cable drag chain has two link plate strands with inner link plates and outer link plates which are successively alternated in the longitudinal direction. In order to limit the pivoting angle, stop projections are provided in an overlap region of the one link plate and engage into corresponding stop pockets in the overlap region of the other link plate. The stop surfaces of a stop projection cooperate with counter-stop surfaces of a stop pocket. The one link plate comprises precisely three stop projections, with a blocking width between their stop surfaces, the angular dimension of each preferably being at least 40°, and that the other link plate comprises precisely three stop pockets which are formed as a depression in this link plate, with an opening width between their counter-stop surfaces, the angular dimension of each preferably being at least 55°. The angular dimension of the blocking width is intended to be at least 50% of the angular dimension of the opening width. A stop projection has a protruding holding element, and a stop pocket has a protruding retaining element, and the holding element and the retaining element cooperate in such a way that they hold connected link plates on one another laterally.

### FIELD

The invention relates in general to the field of energy guide chains for dynamic guidance of lines between two connection points, at least one of which connection points is mobile relative to the other. A core function of energy guide chains consists in keeping the lines, in particular supply lines, such as for example cables for data or power or hoses for operating media, protected during relative motion and in the process to observe a predefined radius of curvature in the “deflection arc” between the chain runs.

### BACKGROUND

To this end, energy guide chains typically have chain links each with two opposing plates (also known as side plates or side pieces). In the case of at least some of the chain links, for example every second chain link, or all the chain links, the plates are connected together by way of at least one, generally two crosspieces. The crosspieces are either fixed or detachable. The chain links define an interior receiving space for guiding the lines, such as for example cables for supplying signals or power or pneumatic or hydraulic hoses. The plates are typically configured such that they ensure a desired maximum swivel angle of the plates relative to one another, said swivel angle determining the radius of curvature in the deflection arc.

Two types have proven very effective specifically in energy guide chains comprising plastics plates. On the one hand, the construction with cranked plates has proven effective, while on the other hand, the construction with alternating inner and outer plates has proven effective.

Plastics plates for energy guide chains are predominantly produced by injection molding. The requirements in this case are completely different compared with energy chains with side plates made of metal.

In the present case, the starting point is a construction with plates of plastics material, namely with alternating inner and outer plates. An energy guide chain of the above type with plates of plastics material according to the teaching of WO 2020/152349 A1 is here considered to be the closest prior art. Two significant advantages of chains with inner and outer plates over cranked plates are improved straight running of the chain, because differences in the length of the two strings are in principle ruled out, and faster assembly.

WO 2020/152349 A1 describes an energy guide chain which is intended for guiding lines between two connection points. The chain links in each case have two opposing plates of plastics material. In the case of at least some of the chain links, the plates are connected together by way of at least one crosspiece. The energy guide chain according to WO 2020/152349 A1 has two plate strings in each case with inner plates and outer plates succeeding one another alternately in the longitudinal direction (=longitudinal direction of the chain), the inner plates having two inner overlap regions facing the inside of the chain and the outer plates having two laterally outer overlap regions facing away from the inside of the chain. Of in each case two plates adjacent in the longitudinal direction in the plate string, the one or a first plate overlaps with one of its overlap regions over a correspondingly complementary overlap region of the other plate or of the second of the two overlapping plates. The two overlapping plates are in each case connected together in articulated manner in a plane so as to be swivelable about a swivel axis. Stop projections and corresponding stop pockets are provided on the plates to limit the swivel angle as intended. The stop projections of the overlap region of one plate engage in the stop pockets of the overlap region of the other plate. Stop faces of a stop projection which act as a limit stop interact with mating stop faces of a stop pocket and bring about swivel angle limitation in the event of relative swivel motion or angling of the two overlapping or connected plates.

### SUMMARY

The present invention relates firstly in particular to the construction or configuration of the limit stop system itself. This is in particular integral to the link plates, and provided in particular in the case of alternating inner and outer plates. The interacting stop faces and mating stop faces are intended to serve, or primarily serve, to predetermine the radius of curvature of the deflection arc by way of which the stationary run of the energy guide chain transitions into the moving run. To this end, the chain links are swivelable or angleable relative to one another by a predefined angle in a first direction of rotation. The stop faces and mating stop faces may have further secondary functions, for example they may contribute to the transfer of tensile and compressive forces in the plate string.

For certain applications it is necessary to enable reverse curvature of the energy guide chain, i.e., swiveling of the chain links relative to one another in a swivel direction opposed to the swivel direction for forming the actual deflection arc, said opposed swivel direction being designated hereinafter as a “reverse” swivel direction. Accordingly, a desired reverse radius of curvature can be understood to mean a predetermined radius of curvature in the direction of rotation contrary to that in the deflection arc. Reverse curvature is in this case contrary to the curvature of the typical deflection arc formed during displacement. In the case of the desired reverse curvature, at least some of the chain links are swivelable or angleable relative to one another by a predefined angle in a second “reverse” direction of rotation opposite to the first direction of rotation.

One of several typical applications which requires a reverse radius of curvature is use of the energy guide chain for circular movement. In this case, the energy guide chain is generally used lying on its side, and the two runs of the energy guide chain can be bent in reverse to follow a circular movement of the moving connection end. However, other applications are also known in which the energy guide chain has a reverse radius of curvature only over certain portions of its length, for example in the case of zig-zag positioning for vertical movements as described in WO 99/54641 A2.

A known approach to being able selectably to adjust the relative swivel angle of the chain links or side plates is the use of radius inserts or radius disks for setting selected radii, these being used selectably interchangeably as separate components in the limit stop system. Such solutions are known, for example, from EP 0499784 A1 or U.S. Pat. No. 4,800,714 A (cf. FIG. 10 therein) or indeed from WO 2010/029092 A1. Disadvantages of such approaches are, inter alia, the reduced mechanical strength of the plate string or the increase in plate width or greater weight required for rigidity, the increase in number of components, wear to the radius inserts or radius disks and, last but not least, greater complexity of assembly and maintenance. Such energy guide chains with radius inserts or radius disks are not regarded here as belonging to the generic type in question.

For energy guide chains of the generic type in question, i.e., those with a limit stop system with stop projections and corresponding stop pockets, which are formed in one piece or integral with the plates, another approach is known for selectably adjusting the relative swivel angle of the chain links or side plates. This approach consists, in essence, in selectably suitably dimensioning the stop pockets in each case. For instance, the dimensions of the stop pockets are reduced in the one swivel direction for relatively large (normal) bend radii. In contrast, to achieve a desired reverse bend radius of the energy guide chain, the dimensions of the stop pockets are enlarged in the other swivel direction. The stop pockets may, in particular, also be enlarged by subsequent machining of the plates, for example by milling. However, this requires there to be sufficient material of the prefabricated plate body to be available between the stop pockets for subsequent removal. This is, in turn, inconsistent with as far as possible maximum utilization of the overlap region to form (mating) stop faces and entails further disadvantages, in particular the post-processing effort involved.

In the generic energy guide chain of WO 2020/152349 A1, the configuration is optimized to the effect that maximum utilization of the plate material or of the volume for providing stop projections and stop pockets is achieved in the overlap region between an inner plate and outer plates. With such an optimized configuration it not straightforwardly possible to provide a desired reverse radius of curvature.

There is a need, in this respect, to propose an improvement with regard to the options for selectably adjusting the desired relative swivel angle of the chain links.

### First Aspect

A first object of the present invention consists in proposing a further development of a generic energy guide chain. The intention is for this in particular to be configured such that desired reverse radii of curvature are also enabled without having to abandon the advantages of the limit stop system with stop projections and stop pockets integrated in the plates, as proposed for example in WO 2020/152349 A1. It is furthermore intended for the limit stop system to provide a stop face which is overall as large as possible alongside a narrow and/or light plate structure. In this respect, it is in particular also intended to propose a further development of the configuration of WO 2020/152349 A1.

This first-mentioned object relating to the first aspect of the invention is achieved with an energy guide chain and with a corresponding side plate pair. Further advantageous embodiments are revealed by the dependent claims.

In particular, an energy guide chain is proposed for guiding lines which has chain links with two mutually opposing plates, in particular of plastics material, wherein at least in some of the chain links the plates are connected together by way of at least one crosspiece.

In its two plate strings, the generic energy guide chain in each case has inner plates and outer plates succeeding one another alternately in the longitudinal direction, the inner plates having two inner overlap regions facing the inside of the chain and the outer plates having two outer overlap regions facing away from the inside of the chain. A construction with cranked plates is thus fundamentally not intended or not regarded as generic in the present case for the first aspect. Of in each case two plates adjoining or directly connected in the longitudinal direction in the plate string, the one or a first plate overlaps with one of its overlap regions over a correspondingly complementary overlap region of the other or of a second connected plate. In the overlapping overlap regions, the two plates are in each case connected together in articulated manner in a plane so as to be swivelable about a swivel axis.

The overlap regions further comprise in each case one integrated limit stop system to limit the swivel angle of the relative swiveling or angling of two connected plates. To this end, stop projections are provided in the overlap region of a (first) plate and corresponding stop pockets are provided in the overlap region of the other (second) plate. The stop projections engage in the stop pockets. The stop projections and stop pockets serve to limit the swivel angle. In this respect, stop faces of a stop projection interact with mating stop faces of a stop pocket to limit the swivel angle, i.e., to predetermine the desired swivel angle, in particular a stop face interacts with a mating stop face in the one swivel direction and an opposing further stop face interacts with an opposing further mating stop face in the opposing swivel direction. Advantageously, the one (first) plate with the stop projections may be the outer plate, and the other (second) plate with the stop pockets may thus be the inner plate. The inverse arrangement is in principle also possible and likewise falls within the scope of the invention.

According to the invention or according to a first aspect of the invention, in particular for the purpose of configuring the integrated limit stop system to achieve the first-mentioned object, a combination of configuration measures is proposed which is distinguished:
in that, in each of the two overlap regions of the one plate, in particular of the inner plate, in each case three, in particular precisely three, stop projections formed in one piece with this plate are provided, wherein the three stop projections in each case have a blocking width between their stop faces with an angular dimension of the blocking width,
in that, in each of the two overlap regions of the other plate, in particular of the outer plate, in each case three, in particular precisely three, stop pockets corresponding to a stop projection and formed as a depression in said plate are provided, wherein the three stop pockets in each case have an opening width between their mating stop faces with an angular dimension of the opening width, and
in that the configuration is dimensioned such that the angular dimension (α) of the blocking width of a stop projection amounts to at least 50% of the angular dimension (β) of the opening width of a stop pocket, wherein this is in any event provided for chain links or plates without a significant reverse bend radius.

According to the invention, the angular dimension (α), acting as a stop, of the blocking width of a stop projection is thus selected from the outset in the configuration according to the invention to be relatively large in relation to the angular dimension (β) of the opening width of a stop pocket, which permits relative swiveling, at least in the case of all the chain links or production series without a reverse bend radius or indeed in production series with only a slight reverse bend radius. The angular dimension of the blocking width of one or each stop projection of a plate preferably amounts in each case to at least 400 (1/9*2π rad), in any event in all the chain links without a reverse bend radius. For sufficiently small deflection radii in the deflection radius, the angular dimension of the opening width diameter of one or each stop pocket of a plate preferably here amounts in each case to at least 550 measured in degrees or 55 degrees (in degrees the round angle is subdivided into 360 parts of equal size, each designated as one degree, with the unit sign “°”).

In the integrated limit stop system for the purposes of the invention, stop projections formed in one piece with the plates strike with their respective stop face in the manner of a stop in particular directly against the corresponding limit stops (mating stop faces) of the stop pockets, i.e., preferably without interposed parts such as for example radius inserts or the like.

The stop projections move on swiveling within the stop pockets and specifically over a circular arc in a circular movement or rotation about the swivel axis. The angular dimension under consideration here relates to the stop action and may in particular be regarded as an angular dimension of the respective arc which stop projections or stop pockets define in a notional circle corresponding to the circular movement about the swivel axis, wherein the configuration and arrangement of the stop faces and mating stop face may be of different types.

The terms angular dimension (α) of the blocking width of a stop projection and angular dimension (β) of the opening width of a stop pocket are in particular to be understood to mean that the difference between the angular dimension (β) of the opening width and the angular dimension (α) of the blocking width results in the desired, predetermined swivel angle between the two chain links. The vertex of the angle considered in each case does not, however, have in particular to coincide with the swivel angle.

The difference between the angular dimension (β) of the opening width of the stop pocket and the angular dimension (α) of the blocking width of a stop projection thus results, in production series without a reverse bend radius, in the desired relative swivel angle in the deflection arc (or “forward” swivel angle). Consequently, the nominal bend radius in the swivel direction may be adjusted to form the deflection arc (not reverse) by modifying the opening width of the stop pockets or by modifying the opening width of the stop pockets. Both options may be achieved by exchanging corresponding (tool) inserts in the molds used for manufacture by injection molding. The bend radius in the deflection arc desired as a function of application is in this case in particular dependent on the chain pitch and on the swivel angle in the deflection arc (in the non-reverse swivel direction).

For relatively large bend radii, the opening width of the stop pockets is preferably reduced, i.e., the blocking width of the stop projections is not modified. In addition or alternatively, however, the blocking width of the stop projections could also be enlarged.

The combination according to the invention of configuration measures consists in essence in providing in each case a limit stop system with precisely or exactly three stop projections and/or stop pockets, wherein, in the case of conventional chain links, stop projections or stop pockets without a reverse bend radius are dimensioned in such a way that the stop projections occupy at least half of the opening width of the stop pockets. This, in retrospect apparently simple, combination of measures makes it possible, in particular while retaining significant advantages from a configuration according to WO 2020/152349 A1, merely to adapt the stop projections with regard to the angular dimension (α) of the blocking width in order to implement reverse bend radii. One disadvantage of the configuration according to WO 2020/152349 A1 was namely recognized that the limit stop system described therein does not in principle enable any reverse bend radii, in any event not without substantial disadvantages.

The first aspect of the invention brings a number of advantages with it. For instance, reverse bend radii can be implemented by exchanging (mold) inserts in the molds used to injection mold the plates, i.e., post-machining of the plates is not necessary. Furthermore, with the given bend radius in the deflection arc for longitudinal portions which are to be equipped with reverse bend radii in this region, only one of the two plates has to be selected to be suitable, in particular only the outer plate with the suitable stop projections, so further simplifying assembly and optionally also subsequent maintenance. In addition, in the case of the other plate with stop pockets, optimum or maximum utilization of the plate body is enabled with regard to stop faces, without modifying strengths by subsequent machining. In particular in longitudinal portions with reverse bend radii, the strength values thus remain substantially unchanged relative to regions of the same design without reverse bend radii. Furthermore, the configuration optionally also permits relatively large reverse bend radii with swivel angles greater than or equal to the conventional or nominal bend radius (in the deflection arc). In addition, the combination with precisely three limit stops per system offers further advantages, for example with regard to flow of forces and reduction in shear forces acting on the articulated joint when the moving run is in the extended position.

A particular advantage of the invention, in particular of a limit stop system with precisely three stop projections or stop pockets, was recognized in the optimized utilization of structural space or volume at the two overlap regions, both of the inner plates and of the outer plates, in particular for the limit stop system or for achieving stop faces.

Since, according to the invention, the blocking width of the stop projections is preset to be relatively large, this may be reduced so as to achieve reverse bend radii without the dimensioning of the stop pockets of a given production series having to be enlarged. Thus, in particular the strength of the plates with the stop pockets, typically of the inner plates, remains unchanged.

According to the invention, an energy guide chain may thus be implemented which is distinguished inter alia in that, in at least one longitudinal portion of the energy guide chain, the angular dimension (α) of the blocking width of the stop projections on the one type of plate or the first plates is selected such that this one type or the first plates, preferably outer plates, are swivelable relative to an extended position (i.e., in a relative position of the two connected plates directed in the longitudinal direction), both in a first swivel direction and in an opposing second, reverse swivel direction relative to the plates connected therewith of the other type or the second plates, preferably inner plates, about the respective swivel axis.

Thus, to implement reverse bend radii the dimensions of the stop projections are adapted relative to the angular dimension (α) of the blocking width, contrary to the known prior art, which either uses radius inserts or enlarges the stop pockets or recesses in the plates, so inter alia disadvantageously reducing the strength of these plates.

For typical bend radii of the deflection arc, for example 125 mm to for example 500 mm or larger depending on application, it is structurally advantageous for the three stop pockets to have an angular dimension of the opening width between their mating stop faces of in each case at least 60° (β≥60° or ≥π/3 rad), wherein the opening width can also be selected to be larger depending on the bend radii, for example β≥70° for bend radii <250 mm in the deflection arc. The specific angular dimension is inter alia dependent on the selected angular dimension (α) of the blocking width of the limit stops or stop projections. This inter alia also permits sufficient dimensioning of the stop projection for the opposing reverse bend radius even in the case of the smallest possible bend radius, optionally with the same swivel angle in both directions relative to the extended position or longitudinal direction.

Particularly preferred embodiments provide for the plate width of the plate string of connected inner plates and outer plates, i.e., the width of the plate string measured in the direction parallel to the swivel axis at the widest points, to amount in each case to at most 25 mm. Preferably, the plates of all the production series according to the invention are dimensioned such that a plate width of ≤20 mm, particularly preferably ≤16 mm, is achieved in the string. In this case, the plates, in particular inner plates and outer plates, are preferably dimensioned with regard to their plate height, measured from narrow side to narrow side (outer height), and plate width such that the ratio of plate width to outer height amounts in each case to ≤20%, particularly preferably ≤18%. The term plate width (of the plate string) relates to the width dimension resulting from half the difference of outer width and inner width of a chain link under consideration, i.e., to a cross-sectional consideration in the plane perpendicular to the longitudinal direction of the chain. Inner plates and outer plates do not necessarily have the same individual width. The two plates connected together as a plate string (also known as a side strap) or connected together as intended in the longitudinal direction form the stated plate width. Subdivision of the individual widths may optionally be different from equal subdivision, i.e., the parting plane between the overlap regions does not have to be central.

In addition or according to an independent further aspect essential to the invention, it may be advantageous for the individual widths of the plates to be differently adjusted, in particular for the individual width of the outer plates to be adjusted to be slightly smaller than the individual width of the inner plates. In this way, relatively high plate string strengths may be achieved with a uniform plate width of the plate string. In this way, the parting plane between the connected overlap regions may preferably lie offset slightly laterally outward, or the outer plates may thus have a smaller wall thickness than the inner plates. For instance, the individual width of the outer plates may amount, for example, merely to around 80% or less of the individual width of the inner plates. A subdivision of the plate width may preferably be selected in which the individual width of the outer plates amounts to ≤45% of the plate width of the plate string, and thus the individual width of the inner plates amounts to ≥55% of the plate width of the plate string.

A relatively thin-walled plate width in absolute terms for a given chain pitch, but in particular in comparison to the plate height, reduces the weight per unit length of the chain and optimizes in particular the ratio of useful internal cross-section to the external cross-section, i.e., achieves optimized utilization of the structural space for the line guide.

In one advantageous embodiment, the stop projections and the stop pockets, when viewed in the longitudinal section of the plates perpendicular to the swivel axis, have in particular a geometric outer contour, which corresponds in each case substantially to a circular ring segment.

In one advantageous embodiment, the stop faces of the stop projections and the mating stop faces of the stop pockets at least predominantly form planar or exactly planar faces which preferably lie substantially perpendicular to the swivel plane. In contrast, however, the faces acting as limit stops may also be produced and oriented at a slight angle, for example slightly obliquely or undercut, such that when in abutment or on loading of the link plates, the faces draw the stop projections together into the stop pockets, as known from WO 95/04231 A1, such that the plates are thereby held laterally stably against one another even in the event of high tensile forces. The angle, relative to the perpendicular to the swivel plane tangential to the face acting as a stop, will here be acute and typically ≤10°. The swivel plane should here be understood, with regard to the respective swivel axis, to mean a plane perpendicular to the swivel axis.

In respect of a circular ring segment contour, the faces acting as stops may in particular be arranged extending parallel to a radius through the swivel axis but offset in the circumferential direction, i.e., not exactly coplanar relative to a radius of the circular movement or to the swivel axis but rather offset parallel thereto. This may likewise enable more favorable force ratios and leverage effects, for example to relieve the swivel joints of tensile and/or shear forces in the self-supporting upper run.

The stop faces and the mating stop faces preferably form predominantly planar faces which may optionally be offset parallel to a radius closest in the circumferential direction through the swivel axis.

In principle, the stop projections of the one plate have a mutually substantially identical angular blocking width dimension between the stop faces thereof. Accordingly, the stop pockets of the other plate have a mutually substantially identical angular opening width dimension between the mating stop faces thereof. The configuration of the limit stop system, in particular the arrangement of the stop projections and pockets, may here in particular correspond in itself to rotational symmetry, in particular with n=3, about the swivel axis. In a swivel plane, the base areas of the stop pockets are thus mutually identical in a considered overlap region, in particular also in all the chain links of a considered energy guide chain. The base areas of the stop projections in a given overlap region are thus identical to one another, but may be differently dimensioned according to the invention over the length of the energy guide chain, in particular in order to implement longitudinal portions with different radii, in particular selectably a reverse bend radius.

In one advantageous embodiment, the stop pockets are provided rotationally symmetrically or uniformly distributed in the circumferential direction about the respective swivel axis, preferably with 120° rotational symmetry relative to the swivel axis.

In one advantageous embodiment, in each case one limit stop arrangement with precisely three stop projections is provided in each overlap region of the one plate to limit the swivel angle. Accordingly, to limit the swivel angle, in each case one limit stop arrangement with precisely three corresponding stop pockets is provided in each overlap region of the other plate, these being configured to match the stop projections.

In a limit stop system embodied or integrated in one piece with the plate body, in particular precisely one stop projection engages in precisely one corresponding stop pocket.

In one advantageous embodiment, the stop projections are in each case only provided on the outer plates and the corresponding pockets in each case only on the inner plates.

The present invention is particularly advantageously, but not exclusively, applicable in combination with a configuration of the outer plate (or inner plate) of the type or principle according to WO 98/46906 A1. In this case, it is advantageous for the outer plates in each case to have a limit stop arrangement with precisely three stop projections in each of their external overlap regions and for the outer plates to be of substantially (though not exactly) mirror-symmetrical construction relative to a first plane of symmetry running in the longitudinal direction and through both swivel axes. Optionally, at variance with this mirror symmetry, the limit stops may be arranged on the inner or outer plates asymmetrically relative to the center axis running as a mirror axis in the longitudinal direction of the chain in such a way that, depending on the orientation of the outer plate relative to the longitudinal direction, the limit angles, defined by the stops, of the angling are different relative to the longitudinal direction of the chain. The two link plate orientations are understood to be the positions of the plate in the longitudinal direction of the chain which transition into one another through 180° rotation about the center axis of the plate running perpendicular to the longitudinal direction of the chain. Thus, by corresponding rotation of the outer plates, another course can be set, in particular pretensioning of the moving run or upper run for applications with a self-supporting upper run. Reference is here made in this respect to the related teaching of WO 98/46906 A1.

Where such outer plates are substantially symmetrical relative to the center plane as mirror plane running in the longitudinal direction of the chain, they advantageously have precisely one or just one stop projection lying in this first plane of symmetry. This stop projection may face the central region, in the longitudinal direction, of the outer plate or be arranged facing away from the central region, in the longitudinal direction, of the outer plate, wherein each of the two arrangements may have their own advantages, for example with regard to force flow or rigidity. The two further stop projections may then optionally lie roughly symmetrically to the first plane.

It is advantageous for the stop faces and the mating stop faces to form at least predominantly planar faces. In this case, it is favorable for rigidity or for relieving the swivel axis if the two stop faces of one stop projection and/or the two mating stop faces of a stop pocket in each case intersect in a notional vertex axis which lies as far as possible centrally relative to the swivel axis within the overlap region. The faces are preferably oriented such that they intersect in a notional vertex axis which lies within a region through a notional incircle radially inside on the circular segment contour of the stop pockets. Provision may particularly advantageously be made for the mating stop faces of a stop pocket to intersect in each case in a notional vertex axis lying within a region defined by a circular ring-shaped joint projection serving as a joint pin or within a circular ring-shaped depression serving as a joint receptacle for receiving a corresponding joint projection of the opposing plate. To this end, the stop faces of a stop projection may be oriented correspondingly or suitably for flat stops.

It is advantageous, in particular for high strength, for the plate, preferably inner plate, to form in each case an outwardly widening material bridge which is preferably substantially V-shaped in longitudinal section between two stop pockets succeeding one another in the circumferential direction about the swivel axis, which bridge has a minimum arc dimension at its narrowest point of ≥3 mm, in particular ≥4 mm, measured in the circumferential direction. The plate may preferably form a peripheral reinforcing ring, into which the material bridges transition radially inward with their narrowest points. In this case, at least these transitions from material bridge to reinforcing ring are preferably in each case of rounded construction.

A particularly robust articulated joint may be achieved by the inner plate having a radially inner joint ring and having, between joint ring and reinforcing ring, a depression serving as a joint receptacle for receiving a corresponding circular ring-shaped joint projection as joint pin of the opposing plate, and by the outer plate having a circular ring-shaped joint projection serving as joint pin, for interaction with the joint receptacle of the inner plate.

In this case, to implement plates of maximally narrow construction, provision may be made for the joint projection or joint pin of the outer plate and the stop projections of the outer plate preferably to protrude inward by a substantially identical amount and to end flush in a plane parallel to the swivel plane.

A favorable utilization of the material volume of the plates in the overlap region is obtained if the stop pockets have an opening height radial to the swivel axis which amounts to at least 15%, preferably at least 20%, of the total height of the plate perpendicular to the longitudinal direction. The stop projections in this case preferably have, radial to the swivel axis, a corresponding radial dimension reduced only by movement clearance. On their circular movement during swiveling, the stop projections may in this case be supported in guided manner within the stop pockets or supported in the manner of a plain bearing.

The invention in particular enables applications in which the energy guide chain comprises at least two longitudinal portions, with at least one first longitudinal portion without a reverse bend radius and at least one second longitudinal portion with a reverse bend radius. In such applications, the energy guide chain has a first longitudinal portion, in which the energy guide chain has no reverse bend radius. In this longitudinal portion, a first type or a first design of one of the plates, preferably a first type of the outer plates, is provided with a first, larger angular dimension (α1) of the blocking width of the stop projections. In a second longitudinal portion, in which the energy guide chain has a reverse bend radius, a second type or a second design of one of the plates, preferably a second type of outer plates, is provided with a second, smaller angular dimension (α2) of the blocking width of the stop projections. The second angular dimension (α2) is here distinctly smaller than the first angular dimension (α1), such that the second type of plates, preferably the outer plates, are swivelable, in each case additionally in an opposing reverse swivel direction relative to the other plates, in particular inner plates.

A plurality of portions with different directions and radii of curvature may in each case be provided, to which then only the first plates, in particular outer plates, are selected to be adapted in their design or selectably to be suitably dimensioned with regard to the blocking width of the stop projections. The second plates, in particular outer plates, may, however, optionally have the same design over the entire chain length of the energy guide chain, in particular the stop pockets may be identically dimensioned in all these plates.

When outer plates with selectably dimensioned stop projections are used, identification of the portions is thus further simplified, since the type or design with regard to swivel angle or radius of curvature can be configured to be more readily apparent from outside, e.g., by way of embossing.

In one preferred configuration of the plates, two holding projections are in each case provided in one piece on a central region of a plate, in particular of the inner plate, said holding projections projecting over an associated space into which in each case an adjacent further plate, in particular outer plate, may engage for lateral stabilization with a circular arc-shaped guide region extending parallel to the swivel plane. This permits increased lateral stability or rigidity of the individual plate strings and thus a high loading capacity under transverse forces for example for applications with a horizontal travel plane rotated by 90° with vertically superposed plate strings. Particularly preferably, a corresponding configuration according to WO 2020/152349 A1 is used. In this case, each holding projection is dimensioned in limited manner (α) in the circumferential direction about the swivel axis, such that the circular arc-shaped guide region of an engaging plate is predominantly not engaged over by the holding projection or each holding projection is arranged about the adjacent swivel axis within an angular range of <60°, preferably ≤45°, bisected by the longitudinal central plane of the plate.

A further reduction in weight per unit length can be achieved if the outer plate has tapered regions at its longitudinal ends of the overlap regions, in which the plate has a thinner material thickness relative to its plate width or the dimension of the plate body parallel to the swivel axis than in its central region therebetween. In this case, to increase strength, in particular with regard to tensile and compressive forces, the interposed region may extend with regions of greater material thickness compared with the tapered regions in the longitudinal direction preferably over at least 80% of the chain pitch. This interposed region with a greater material thickness compared with the tapered regions may in this case also be used as a wear supplement for laterally horizontal applications, for example in the case of circular chain applications. In structurally advantageous manner, provision is in particular made for this interposed region to be dimensioned with a greater material thickness in the longitudinal direction in such a way that it covers at least 25% of the diameter of the circular ring-shaped joint pin or the joint receptacle. In this way, forces acting on the articulated joint may be introduced directly into the region with greater material thickness.

The configuration according to the invention of the plates is particularly advantageous for industrial applications with comparatively large chains, in particular energy guide chains with external plate heights ≥40 mm and/or with chain pitches ≥80 mm, wherein the chain pitch corresponds to the distance between the swivel axes, which is preferably but not necessarily identical for outer plates and inner plate. The configuration according to the invention of the plates inter alia permits a lighter design, which is thus also suitable for example for higher speeds, compared for example with WO 2020/152349 A1.

The configuration according to the invention of the plates for achieving reverse bend radii can be used with advantage for various applications or uses, for example if the energy guide chain is used for circular movement or if the energy guide chain is used for a vertical movement with a plurality of first extended length portions, in particular without reverse bend radius, which can be positioned above one another in a zig-zag shape and which are in each case connected by way of second portions with a reverse bend radius.

The invention relates, in addition to an energy guide chain as a whole, also to the individual link plates themselves used for this purpose and their paired connection to form a plate pair in each case with the configuration according to the invention with one or more of the features discussed above.

The side plate pair for an energy guide chain is distinguished by a first plate, in particular outer plate, and a second plate, in particular inner plate, in each case with the features according to one of the above embodiments.

The invention also further relates to a corresponding chain link pair with two such laterally opposing plate pairs of inner and outer plates, which are connected by way of at least one crosspiece.

The above embodiments are particularly advantageously applicable to link plates for energy chains which are made in one piece or integrally from a plastics material, preferably from an injection-moldable thermoplastic, in particular a fiber-reinforced thermoplastic or engineering polymer.

### Second Aspect

According to an independent further aspect considered in itself to be essential to the invention, a further development of generic energy guide chains with inner and outer plates is proposed which simplifies assembly of the plate string and/or increases lateral stability to a greater extent.

In this case, a generic energy guide chain serves to guide lines, such as hoses, cables or the like, between two connection points, with chain links, which in each case comprise two opposing plates, in particular of plastics material. In the case of at least some of the chain links, the plates are connected together by way of at least one crosspiece. The energy guide chain has two plate strings in each case with inner plates and outer plates succeeding one another alternately in the longitudinal direction, the inner plates having two inner overlap regions facing the inside of the chain and the outer plates having two outer overlap regions facing away from the inside of the chain. Of in each case two plates adjacent in the longitudinal direction in the plate string, where the one plate overlaps with one of its overlap regions over a correspondingly complementary overlap region of the other plate, the two plates are in each case connected together in articulated manner in a plane so as to be swivelable about a swivel axis.

To limit the swivel angle, stop projections are generically provided in the overlap region of the one plate which engage in corresponding stop pockets provided in the overlap region of the other plate.

The independent second aspect proposes that at least one stop projection has a radially protruding holding element and at least one corresponding stop pocket has a radially protruding retaining element, wherein holding element and retaining element interact in such a way as to hold connected plates laterally against one another.

This simple additional measure significantly simplifies assembly of the plate strings. Independently thereof, the configuration also increases lateral stability in operation, which is advantageous in particular but not solely in combination with plates of narrow structure according to the first aspect.

In one embodiment, each of precisely two stop projections, in particular just two of the precisely three stop projections, in each case have a radially protruding holding element. Accordingly, the two corresponding stop pockets interacting in each case with the two stop projections have a radially protruding, interacting retaining element.

In one embodiment, each holding element and each retaining element is in each case provided on the radially outer circumferential region of the stop projection or of the stop pocket.

It is structurally advantageous for holding element and retaining element in each case to extend circumferentially or in arcuate manner, such that engagement is achieved over a given swivel angle range.

In an embodiment that is simple to produce, the or each of the holding elements and retaining elements may in each case be embodied as a radially protruding latching lug, in particular with an insertion bevel oblique relative to the swivel plane and a latching surface parallel to the swivel plane, and preferably is detachably latchable together with the in each case interacting element when the plates are joined together. In this way, for example, a snap-fit connection or latching together of the plates which is easy to connect and undo again can be achieved.

One embodiment provides for two holding elements on stop projections of the outer plate to be provided symmetrically relative to a longitudinal central plane, and for two retaining elements to be provided asymmetrically relative to a longitudinal central plane in corresponding stop pockets of the inner plate.

In addition or as an alternative, two retaining elements are angularly offset relative to one another and to the swivel axis in corresponding stop pockets and/or embodied with different angular dimensions about the swivel axis. This makes it possible inter alia for holding elements and retaining elements in each case to hold connected plates laterally against one another at least over a major proportion of the swivel angle, interaction thereof being a result in each case of the angular position of the plates.

The first and second aspects may be implemented mutually independently with standalone advantages or also particularly advantageously in combination.

All the above-stated features and those explained below as being advantageous are considered, alone or independently, and also in advantageous combination, to be essential to the invention and may thus constitute the subject matter of a divisional application.

### BRIEF DESCRIPTION OF THE DRAWINGS

Further features and advantages of the invention may be inferred without limitation of the scope of protection from the following, more detailed description of preferred exemplary embodiments made on the basis of the appended figures, in which, merely by way of example:

FIGS. 1A-1B show a perspective view of a portion with two chain links of a first exemplary embodiment of the invention (FIG. 1A), and a vertical longitudinal section roughly along the parting plane between the plates (FIG. 1B), to illustrate the limit stop system;

FIG. 2 shows a schematic side view of an energy guide chain displaceable in a vertical plane with self-supporting upper run (and pretensioning), to illustrate the (normal, non-reverse) bend radius in the deflection arc;

FIGS. 3A-3B show a perspective view of the inside of an outer plate (FIG. 3A) and a perspective view of the outside of an inner plate (FIG. 3B) to further illustrate the limit stop system, in each case according to a variant of the first exemplary embodiment, here with smaller bend radius in the deflection arc;

FIGS. 3C-3E show a portion of a plate string with inner and outer plates according to FIGS. 2A-2B, in plan view (FIG. 3C) to illustrate the small plate width, and in side view (FIG. 3D) and in vertical longitudinal section roughly along the parting plane (FIG. 3E) between the plates to illustrate the nominal swivel angle limitation (in the deflection arc) by the limit stop system;

FIGS. 4A-4B show a perspective view of the inside of an outer plate (FIG. 4A) and a perspective view of the outside of an inner plate (FIG. 4B) of a further exemplary embodiment, here with bend radius as in FIGS. 3A-3B;

FIGS. 5A-5B show a further exemplary embodiment in the vertical longitudinal section roughly along the parting plane to illustrate a longitudinal portion of the plate string with normal swivel angle limitation (FIG. 5A) and intended reverse, opposed swivelability for a reverse bend radius (FIG. 5B) with substantially the same swivel angle;

FIG. 6 shows a schematic plan view, as first exemplary application, of a circular chain application with an energy guide chain according to the invention for circular movement;

FIGS. 7A-7B show a schematic side view, as second exemplary application, of an energy guide chain according to the invention for vertical movements; and

FIGS. 8A-8F show a further development according to a second independent aspect of the invention, showing a preferred embodiment with latching function on the integrated limit stop system, in longitudinal section (FIG. 8A, corresponding to section line A-A in front view FIG. 8E), in cross-section (FIG. 8B, corresponding to section line B-B in side view FIG. 8F), in perspective view of holding element (FIG. 8C) and mating holding element (FIG. 8D) and in front view (FIG. 8E) and side view (FIG. 8F), of a side plate pair consisting of outer and inner plates.

### DETAILED DESCRIPTION

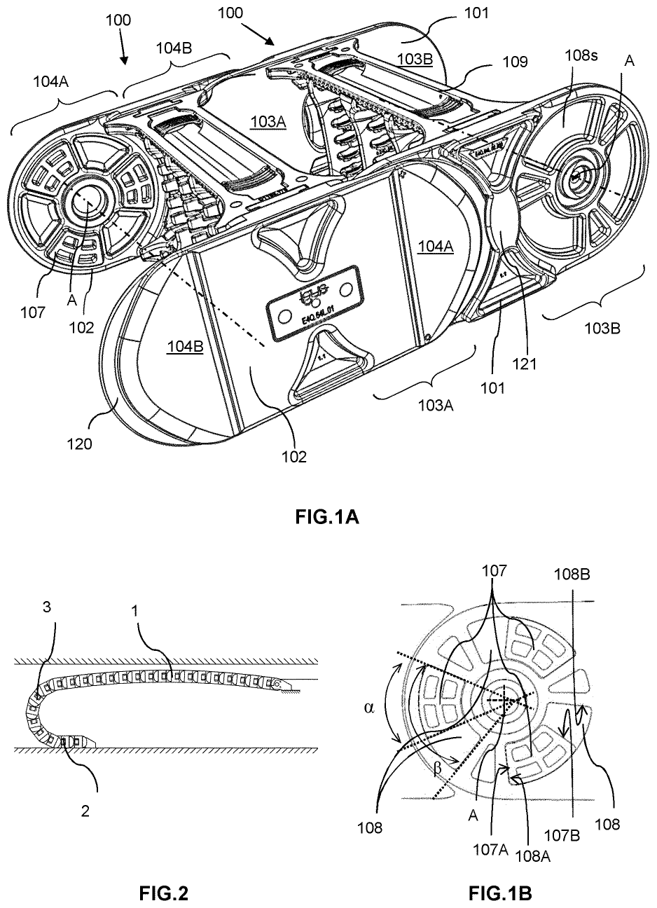

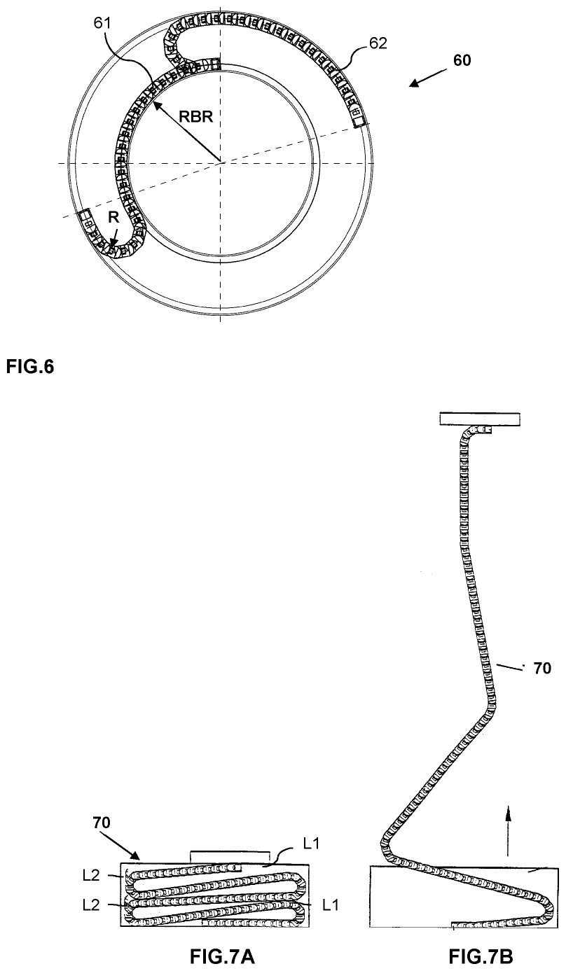

FIG. 1A shows two chain links 100 as basic components of an energy guide chain for guiding supply lines (not shown) having at least two runs connected by a deflection arc and displaceable as a function of application (cf. FIG. 2, FIG. 6 or FIG. 7).

The chain links 100 are composed of inner plates 101 and outer plates 102 succeeding one another alternately in the longitudinal direction of the chain. Pairs of laterally opposed inner plates 101 and outer plates 102 are connected together in fully cross-pieced manner with two crosspieces 109 on each chain link 100; however, the crosspieces 109 may also be provided on only every second chain link 100.

The inner plates 101 have two inner overlap regions 103A, 103B facing the inside of the chain or receiving space in the chain link 100. The outer plates 102 have two outer overlap regions 104A, 104B facing away from the inside of the chain. If in each case two plates connected in the longitudinal direction in the plate string are considered, the one plate 101 or 102 overlaps, with one of its overlap regions 103A, 103B or 104A, 104B respectively, over a correspondingly complementary overlap region 104A, 104B or 103A, 103B respectively of the other plate 102 or 101.

By way of suitable articulated joints (see below), the two plates 101, 102 are in each case connected together in articulated manner so as to be swivelable in a plane about a swivel axis A, such that the chain links 100 can be swiveled relative to one another to form a deflection arc 3 (cf. FIG. 2).

The construction of the chain links is based, in terms of features which do not relate to the side plates per se, on the construction from WO 2020/152349 A1, to the teaching of which reference is made and the content of which is included here for the sake of brevity, for example with regard to two holding projections 121 provided at a central region 105 of the inner plate 101 and which project over a space into which in each case an adjacent outer plate 102 engages for lateral stabilization with a circular arc-shaped guide region 120 extending parallel to the swivel plane.

The construction of the manually detachable crosspieces 109 (i.e., the crosspieces 109 detachable without use of a tool) and the fastening projections provided for this purpose on the upper and lower narrow sides of the plates 101 or 102 is also known, and to this end reference is made, for the sake of brevity, to the teaching of WO 2020/152263 A1, the content of which is included here, in particular in relation to the construction and fastening of the crosspieces 109. Furthermore, FIG. 1A shows an inner subdivision, which may be of a per se known type, reference being made for the sake of brevity to the teaching of WO 2022/049091 A1, the content of which is here included in relation to the inner subdivision.

The inner plates 101 and outer plates 102 are one-part or one-piece plates of plastics material, in particular of a fiber-reinforced engineering polymer, produced by injection molding. Below, differences with regard to the teaching of WO 2020/152349 A1 will be discussed, above all in relation to the integrated limit stop system, which is produced in one piece with the inner plates 101 and outer plates 102.

To limit the swivel angle, the outer plates 102 according to the invention in each case have precisely three stop projections 107 in each case on the inside in each of their overlap regions 104A, 104B. The stop projections 107 are produced in one piece with the plate body, for example during injection molding, and protrude inward into the receiving space of the chain link.

In both overlap regions 103A, 103B of the inner plate 101, in each case precisely three corresponding stop pockets 108 are preformed as depressions or recesses during production or recessed by corresponding mold inserts. The stop pockets 108 are configured and dimensioned to match the stop projections 107, such that the stop projections 107 are received swivelably in the stop pockets 108.

The stop projections 107 and the stop pockets 108 are in each case arranged rotationally symmetrically with N=3, i.e., rotationally symmetrically by 1200 about the respective swivel axis A. In the assembled state of the plate string, the stop projections 107 engage in the stop pockets 108 and serve to limit the swivel angle.

As is apparent from FIG. 1B, the outer stop faces 107A, 107B of a stop projection 107 in each case interact with mating stop faces 108A, 108B of a stop pocket 108 to limit the swivel angle, in each case in both swivel directions, for example in the extended position of the runs 1, 2 or in the deflection arc 3 (FIG. 2). In this case, a stop face 107A, 107B of a stop projection 107 in each case comes to rest against the matching or corresponding mating stop face 108A, 108B of a stop pocket 108, so predetermining the maximum admissible swivel angle of the chain links relative to one another in both swivel directions.

As is apparent from FIG. 1B, all three stop projections have a blocking width which is substantially identical (optionally down to a few tenths) between their stop faces 107A, 107B with an angular dimension of the blocking width which amounts to at least 40° (α≥40°), if no reverse bend radius is provided, as shown for example in FIGS. 5A-5B. The three stop pockets 108 have an opening width between their mating stop faces 108A, 108B, which is adapted to the desired swivel angle, with an angular dimension of the opening width, wherein the angular dimension of the opening width preferably amounts in each case to at least 55° (β≥55°) depending on the desired radius of curvature in the deflection arc 3 (cf. FIG. 2). According to the invention it is here provided that, for all production series without reverse bend radius, the angular dimension α of the blocking width of each stop projection 107 amounts to at least 50% of the angular dimension β of the opening width of a stop pocket 108, as illustrated by way of example in FIG. 1B.

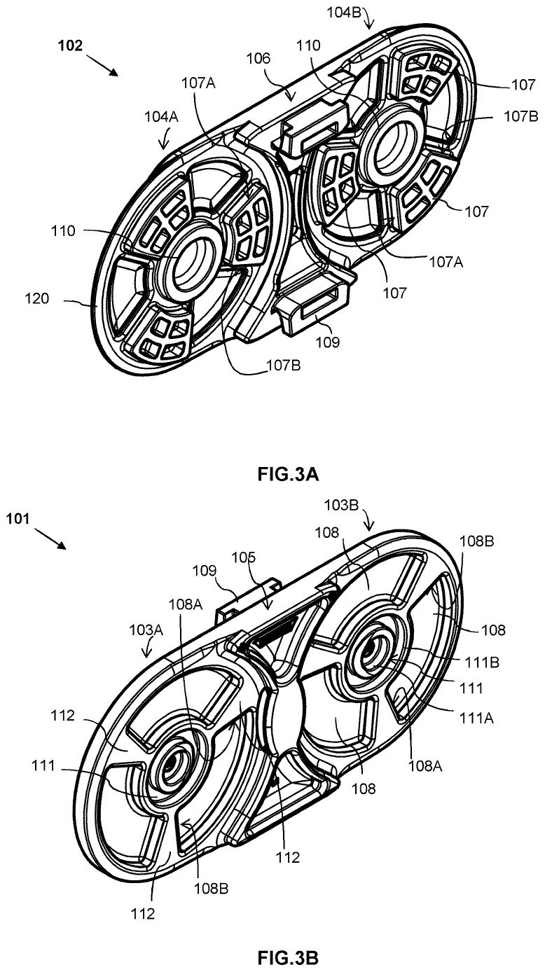

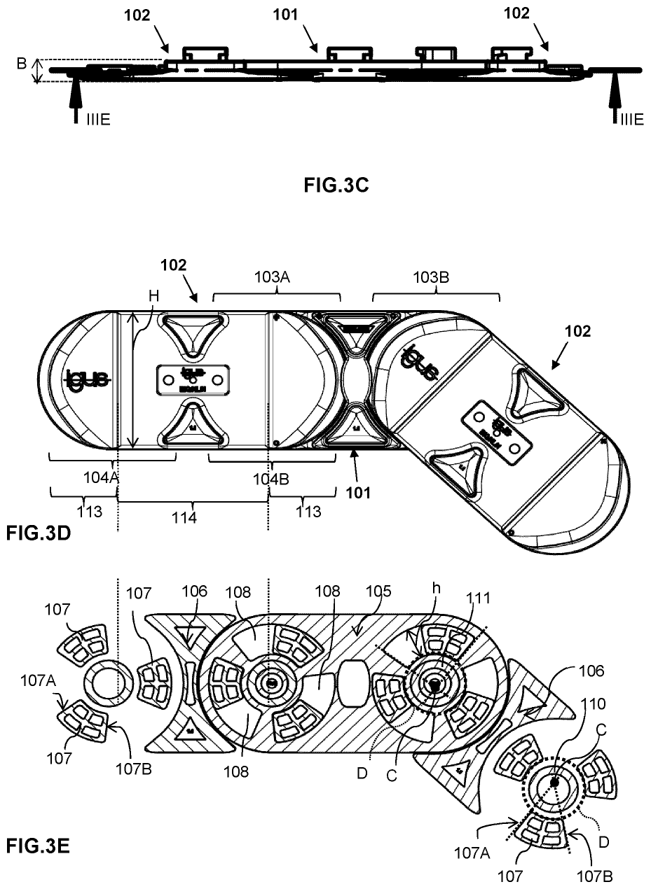

FIGS. 3A-3B show a preferred geometry of the integrated limit stop system comprising stop projections 107 on the inside of the outer plates 102 and stop pockets 108 on the outside of the inner plates 101. The stop projections 107 and the stop pockets 108 have a contour in the longitudinal section of the plates perpendicular to swivel axis A, as shown in FIG. 1B, which corresponds in each case substantially to a circular ring segment, and are arranged rotationally symmetrically or circumferentially evenly distributed about the respective swivel axis A. The stop projections 107 of the outer plate 102 have a mutually substantially identical angular dimension of the blocking width α between their stop faces 107A, 107B (cf. FIG. 1B). The stop pockets 108 of the inner plate 101 have a mutually substantially identical angular dimension of the opening width β between their mating stop faces 107A, 107B (cf. FIG. 1B), as is apparent from FIGS. 3A-3B. The stop faces 107A, 107B of the stop projections 107 and the mating stop faces 108A, 108B of the stop pockets 108 here in each case form a predominantly planar face which lies substantially perpendicular to the swivel plane or the swivel axis A, or optionally at a slightly acute angle, such that the plates 101, 102 are drawn into abutment in the limit stop.

As is further apparent from FIGS. 3A-3B, the integrated limit stop system to limit the swivel angle in each case has an arrangement with precisely three stop projections 107 in each overlap region of the outer plate 102 and accordingly a limit stop arrangement with precisely three corresponding stop pockets 108 in each overlap region of the inner plate 101. In the assembled state, precisely one stop projection 107 then engages in precisely one corresponding stop pocket 108, and no other separate components, such as radius inserts or radius disks, for predetermining selected radii, are provided in the limit stop system.

FIG. 3C depicts the narrow plate width B of the plate string of connected inner plates 101 and outer plates 102, here shown with a portion consisting of one inner plate 101 and two outer plates 102 in plan view. The plate width B of the plate string amounts, when measured in a direction parallel to the swivel axis A, to at most 25 mm, preferably to ≤20 mm, particularly preferably ≤16 mm. The ratio B/H of plate width B to outer height H (cf. FIG. 3D) amounts in each case to ≤20%, particularly preferably ≤18%, wherein this ratio is optionally dependent on the production series or selected structural height.

FIGS. 3D-3E further show, using broken lines, that the outer plate 102 has a thinner material thickness in tapered regions 113 at longitudinal ends of the overlap region 104A, 104B in each case relative to its plate width than in its central region 106 therebetween. A region 114 lies therebetween which has a greater material thickness relative to the tapered regions 113. This region 114 extends in the longitudinal direction L preferably over at least 80% of the chain pitch and/or in particular covers at least 25% of the diameter of the circular ring-shaped joint pin or joint projection 110. This further increases stability in the case of thin plates 102.

FIG. 3E shows a longitudinal section through the plates of FIG. 3C corresponding to section line IIIE-IIIE. As may be seen here, the two stop faces 107A, 107B of a stop projection 107 are in each case oriented, for all the stop projections 107, in such a way that the substantially planar stop faces 107A, 107B intersect in a notional vertex axis C (cf. in FIG. 3E, perpendicular to the plane of the drawing) which lies within the corresponding overlap region 104A, 104B, namely preferably within a region through a notional incircle D which lies radially to the inside of the circular ring segment contour of the stop projections 107 or likewise of the stop pockets 108. The incircle D is shown schematically in FIG. 3E by a broken line in relation to the right-hand plate pair. The same applies mutatis mutandis also to the mating stop faces 108A, 108B of each stop pocket 108. The resultant three notional vertex axes C (just one is shown by way of example) do not here coincide with the swivel axis A but rather lie distributed about it. In FIG. 3E for the sake of simplicity just one example is shown of each of vertex axis C and incircle D, but due to the rotational symmetry the same geometry applies, mutatis mutandis, to all the stop projections 107 and stop pockets 108.

FIGS. 3A-3B in turn offer the clearest depiction of details of the structure of the preferred articulated joint which connects the inner plates 101 and outer plates 102 in each case in articulated manner in a plane so as to be swivelable about a swivel axis A, such that the chain links 110 are swivelable relative to one another. To this end, in each of its overlap regions 103A, 103B, the inner plate 101 has a radially inner joint ring 111A and a reinforcing ring 111B to the outside thereof which are arranged coaxially to swivel axis A. Here too, a circular ring-shaped depression forming a joint receptacle 111 is provided between the joint ring 111A and the reinforcing ring 111B. This joint receptacle 111 serves to receive a corresponding, circular ring-shaped joint projection 110 on the connected overlap region 104A, 104B of the opposing outer plate 102. The annular joint projection 110 serving as a joint pin is slidingly rotatable in the joint receptacle 111, such that joint projection 110 and joint receptacle 111 form a revolute joint for swiveling the connected plates 101, 102 relative to one another about the thus defined swivel axis A.

As is also apparent from FIGS. 3A-3C, the joint projection 110 of the outer plate 102 and the stop projections 107 of the outer plate 102 preferably protrude laterally by a substantially identical amount relative to the inner space or the inner plate 101, and preferably end flush in a plane parallel to the swivel plane (cf. FIG. 3C, left). FIGS. 3A-3C furthermore show that the inner plate 101 forms in each case an outwardly widening material bridge 112 between two stop pockets 108, which material bridge is here of substantially V-shaped configuration in longitudinal section. The circumferential reinforcing ring 111B formed by the inner plate 101 here transitions in each case into one of three material bridges 112 in the space between each pair of stop pockets 108. At this point, the material bridges 112 preferably have a minimum arc dimension of ≥3 mm, in particular ≥4 mm at their narrowest point, measured in the circumferential direction or roughly perpendicular to a radius applied thereto. This configuration strengthens the limit stops of the stop pockets 108 on the one hand and at the same time also the joint receptacle 111, in particular the reinforcing ring 111B, by spoke-like bracing to a further outer reinforcing ring 111C, which transitions into the central region 105 of greater material thickness. The stop pockets 108 are closed toward the inside or at the base area remote from the outer plate 102 by a continuous sheet-like material region of the inner plate 101, i.e., are embodied as depressions open to the outer plate 102 on only one side.

As is additionally clear from joint consideration with FIG. 3E, the two mating stop faces 108A, 108B of one stop pocket 108 are in each case oriented such that they intersect in the notional vertex axis C which lies, for each of the three stop pockets 108, radially within a region defined by a circular ring-shaped joint projection 110 serving as a joint pin or correspondingly radially within the circular ring-shaped depression serving as a joint receptacle 111 of the opposing plate, since joint projection 110 and joint receptacle 111 lie within the notional incircle D (cf. FIG. 3E). This configuration furthermore increases the stability of the plate strings when in operation, which is advantageous in particular with preferably thin-walled plates 101, 102.

As FIGS. 1B, 3B and 3E show, the stop pockets 108 configured with an identical base area in the swivel plane have an opening height h (cf. FIG. 3E) radial to the swivel axis A which occupies a relatively large proportion of the structural height of the plate, for example amounts to at least 15%, preferably at least 20% of the total height H of the plate 101 perpendicular to the longitudinal direction. The stop projections 107 have, radial to the swivel axis A, a corresponding radial dimension reduced only by movement clearance.

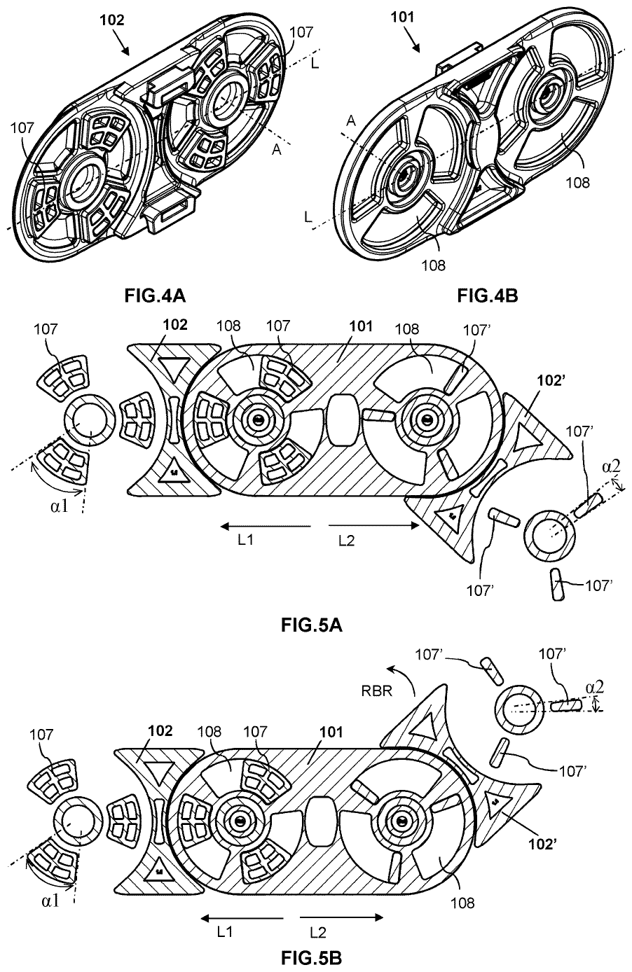

FIGS. 4A-4B show an alternative embodiment with integral limit stop arrangement. Here, the inner plates 101 initially, as in the example of FIGS. 1-3, have in each of their overlap regions 103A, 103B a limit stop arrangement with in each case precisely three stop pockets 108 and the outer plates 102 in each case have in each of their overlap regions 104A, 104B a limit stop arrangement with precisely three stop projections 107. Also, as in the example of FIGS. 1-3, the outer plates 102 are of substantially mirror-symmetrical construction with regard to a first plane of symmetry running in the longitudinal direction and through both swivel axes A, optionally with slight asymmetry for selectably adjusting the pretensioning of the upper run 1 (cf. FIG. 2).

The difference in the embodiment in FIGS. 4A-4B consists in the fact that the outer plates 102 in the example of FIGS. 1-3 have a stop projection 107 lying in the first plane of symmetry, which stop projection faces the region 105, central in the longitudinal direction L, of the outer plate 107, whereas in the example of FIGS. 4A-4B the outer plates 102 have a stop projection 107 lying in the first plane of symmetry, which stop projection 107 in each case faces outward in the end region of the overlap region 103A, 103B, i.e., away from the central region 105 of the outer plate 102 when viewed in the longitudinal direction L. The first plane of symmetry is here formed by the longitudinal direction L and the parallel swivel axes A or defined by the swivel axes A. In the example of FIGS. 4A-4B, the three stop pockets 108 of the inner plates 101 are accordingly distributed correspondingly about the swivel axis, such that the desired swivel angle is achieved, in particular for the deflection arc 3 (FIG. 2).

Furthermore, the inner plates 101 and outer plates 102 in the example of FIGS. 4A-4B are provided with the same features as those in the example of FIGS. 1-3.

A significant advantage of the first aspect of the invention or of the proposed limit stop system will be explained with reference to FIGS. 5A-5A. FIGS. 5A-5B show a portion with only three plates, wherein the energy guide chain comprises at least two longitudinal portions, with a first longitudinal portion L1, in which the energy guide chain does not have a reverse bend radius (=RBR) and a first type of outer plates 102 is provided, which may be embodied for example as in FIGS. 1-3 or FIG. 4. The first type of outer plates 102 has a first, larger angular dimension α1 of the blocking width of its three identically constructed stop projections 107, cf. FIGS. 5A-5B.

In a subsequent second longitudinal portion L2, in which the energy guide chain has a reverse bend radius, depicted as swivel direction RBR, a second type of outer plates 102′ is provided. The second type of outer plates 102′ is very largely of like construction to the first type of outer plates 102 and in particular is compatible and/or connectable with the same inner plate 101. The second type of outer plates 102′ differs only in that it has stop projections 107′ of smaller dimensions, namely with a second, smaller angular dimension α2 of the blocking width of the stop projections 107′, wherein the second angular dimension α2 is in particular markedly smaller than the first angular dimension α1 of the stop projections 107 of the first type of outer plates 102. This makes it particularly simple to provide an RBR, by making the second type of outer plates 102′ additionally swivelable in an opposing, reverse swivel direction RBR due to the stop projections 107′ of smaller dimensions. This takes place without modification of the inner plate 101, which is used uniformly in both longitudinal portions LI, L2. FIGS. 5A-5B here show only exemplary swivel angle limitations or angular dimensions α1, α2, which can of course also be selected to be different without departing from the basic principle. As FIGS. 5A-5B illustrate, the first aspect of the invention makes it possible for just the stop projections 107 or 107 to have selectably to be adapted with regard to the angular dimension (α) of the blocking width in order to implement reverse bend radii RBR. This may, for example, be achieved simply and inexpensively by easily exchangeable mold inserts in the injection mold.

FIG. 6 shows a circular chain application as an exemplary application of an energy guide chain 60 for circular movement in a first end position and a second end position. The energy guide chain 60 has a radially inner run 61 and radially outer run 62, connected by way of a deflection arc 63. The energy guide chain 60 is arranged to move laterally horizontally with the runs 61, 62 and has, as intended, a reverse bend radius RBR which is comparatively large compared with the nominal bend radius R of the deflection arc 63. The RBR is needed in circular chain applications to position the radially inner run 61 against the inner ring of the circular guide. The reverse bend radius RBR may here be achieved, according to the principle of FIGS. 5A-5B or according to the first aspect of the invention, with virtually any desired radius by appropriate selection of the angular dimensions α1 or α2.

FIGS. 7A-7B are schematic representations of an energy guide chain 70 for vertical applications. This has short longitudinal portions L2 with a reverse bend radius as intended in each case between longitudinal portions L1 without RBR for the purpose of zig-zag positioning of the energy guide chain in the retracted state, as shown in FIG. 7A. FIG. 7B shows the energy guide chain 70 in a vertically advanced state. It should be noted that FIGS. 6-7 serve merely to illustrate exemplary applications and do not show the chain of inner and outer plates according to the invention.

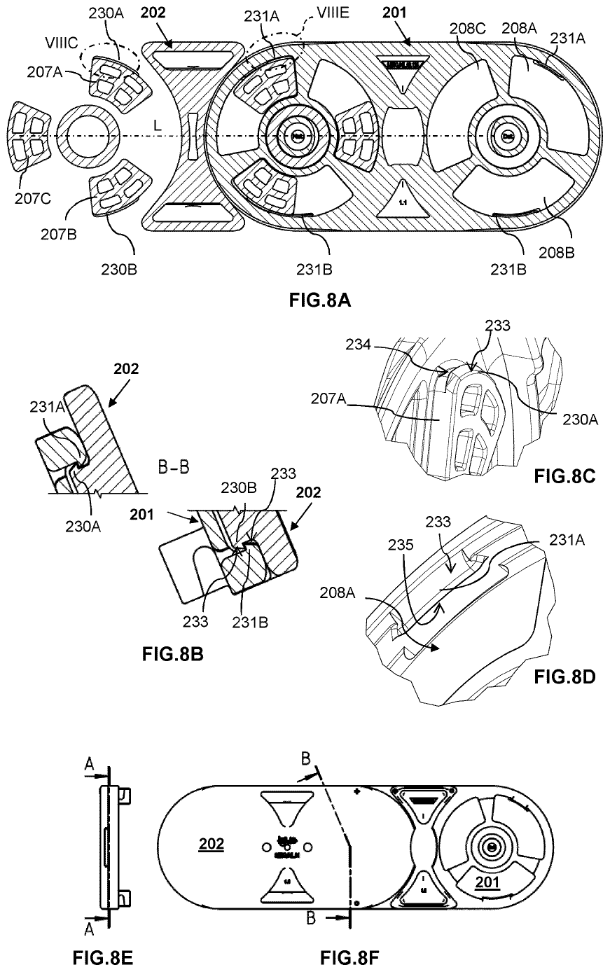

FIGS. 8A-8F show a side plate pair consisting of inner plate 201 and outer plate 202 according to a further aspect of the invention. The fundamental features of the inner plate 201 and outer plate 202 may here correspond to the example of FIGS. 1-3 or FIG. 4. For brevity's sake, only the differences or further developments will be looked at.

The integrated limit stop system to limit the swivel angle is in principle identical to the previous examples. The inner plate 201 here too has in each case three stop pockets 208A, 208B, 208C in the two inner overlap regions 203A, 203B, the stop action, geometric arrangement and contour of which correspond to the first aspect or above description apart from the following differences. Similarly, the outer plate 202 here too has in each case three stop projections 207A, 207B, 207C in the two outer overlap regions 204A, 204B facing away from the inside of the chain, the stop action, geometric arrangement and contour of which correspond to the first aspect or above description apart from the following differences.

The essential difference consists in the fact that two of the three stop projections 207A, 207B have a radially protruding holding element 230A, 230B. The corresponding two stop pockets 208A, 208B have an interacting radially protruding retaining element 231A, 231B.

As is most apparent from FIG. 8B, in each case one holding element 230A, 230B and one corresponding retaining element 231A, 231B interact in such a way to connect the plates 201, 202 together laterally in the direction of the swivel axis that they hold the connected plates against one another laterally of or parallel to the swivel axis A.

However, the stop projection 207C lying in the central region and the corresponding stop pocket 208C in each case preferably do not have a holding element or mating element for this purpose (retaining element), as is apparent from FIG. 8A.

Each holding element 230A, 230B and each retaining element 231A, 231B are in each case arranged in protruding manner on the radially outer circumferential region of the associated stop projection 207A, 207B or the associated stop pocket 208A, 208B and produced in one piece with the latter in the injection molding process.

As is apparent from FIGS. 8A-8D, the retaining elements 231A, 231B are in each case configured to extend circumferentially or arcuately and protrude radially outward from the stop projections. The retaining elements 231A, 231B are in each case configured to protrude radially inward on the outer reinforcing ring or the radially outer edge of the stop pocket 208A, 208B and likewise extend arcuately in the circumferential direction.

As is illustrated in FIG. 8B, holding elements 230A, 230B and retaining elements 231A, 231B are preferably embodied in the manner of a radially protruding latching lug or with a cross-section in the manner of a snap hook. To simplify connection of the plates, holding elements 230A, 230B and retaining elements 231A, 231B in each case have an insertion bevel 233 oblique relative to the swivel plane and a latching surface 234; 235 parallel to the swivel plane, by way of which the holding elements 230A, 230B engage behind the retaining elements 231A, 231B or vice versa and in this way can be simply but stably detachably latched together with the in each case interacting element on lateral joining together of the plates.

On the outer plate 202, the two holding elements 230A, 230B are provided symmetrically relative to a longitudinal central plane on the two stop projections 207A, 207B of the outer plate 202 facing the central region. On the inner plate 202, in contrast, two retaining elements 231A, 231B are provided asymmetrically relative to a longitudinal central plane in corresponding stop pockets 208A, 208B of the inner plate 201. This makes it possible for the outer plate 202 to remain connectable to the inner plate 201 over 180° to adjust pretensioning.

The asymmetry of the retaining elements 231A, 231B relative to the longitudinal central plane permits the connected plates to be held laterally against one another at least over a major proportion of the swivel angle. This is preferably achieved by the two retaining elements 231A, 231B being angularly offset in or on the corresponding stop pockets 208A, 208B in respect of swivel axis A and/or being provided with a different angular dimension about the swivel axis A. The dimension in the circumferential direction, distribution and other configuration of the holding elements 230A, 230B and retaining elements 231A, 231B may also be provided differently from the example shown here. Because the connected plates 201, 202 are connected together or held against one another, the second aspect permits simplified assembly and moreover increases the lateral stability of the plate connection.

This further aspect according to FIGS. 8A-8F may also be applied independently of the first aspect and for example with a different number of stop projections and stop pockets, for example to improve the configuration according to WO 2020/152349 A1. Advantageously, the configuration according to FIGS. 8A-8F may also be combined with holding projections 121, which project over a space in which in each case one adjacent outer plate 102 engages for lateral stabilization with one circular arc-shaped guide region 120 extending parallel to the swivel plane, as shown in FIG. 1A, to bring about further improved lateral stabilization.

### LIST OF REFERENCE SIGNS

### FIGS. 1-5:

1 Upper run
2 Lower run
3 Deflection arc
100 Chain link
101 Inner plate
102, 102′ Outer plate
103A, 103B Overlap regions (inner plate)
104A, 104B Overlap regions (outer plate)
105 Central region (inner plate)
106 Central region (outer plate)
107, 107′ Stop projections
108 Stop pockets
109 Crosspiece
110 Joint projection
111 Joint receptacle
111A Joint ring
111B, 111C Reinforcing ring
112 Material bridge
113 Tapered end region (outer plate)
114 Intermediate region (outer plate)
120 Guide region
121 Holding projections
A Swivel axis
B Plate width
C (Notional) vertex axis C
D Incircle
E Plane of symmetry
h Opening height (stop pocket)
H Total height
LI First longitudinal portion (without RBR)
L2 Second longitudinal portion with RBR
RBR Swivel direction for RBR
α Blocking width, stop projections
β Opening width, stop pockets

### FIGS. 6-7:

60 Energy guide chain (circular chain with RBR)
61 Radially inner run
62 Radially outer run
63 Deflection arc
R Nominal bend radius
RBR Reverse bend radius
70 Energy guide chain for vertical application
L1 First longitudinal portion (without RBR)
L2 Second longitudinal portion with RBR

### FIGS. 8A-8F

201 Inner plate
202 Outer plate
203A, 203B Overlap regions (inner plate)
204A, 204B Overlap regions (outer plate)
207A, 207B, 207C Stop projections
208A, 208B, 208C Stop pockets
230A, 230B Holding element
231A, 231B Retaining element
233 Insertion bevel
234; 235 Latching surface

What is claimed is:

1-23. (canceled)

24. An energy guide chain for guiding lines, such as hoses, cables or the like, between two connection points, with chain links which in each case comprise two opposing plates, of plastics material, the plates being connected together, in the case of at least some of the chain links, by way of at least one crosspiece, the energy guide chain having two plate strings in each case with inner plates of plastics material and outer plates of plastics material succeeding one another alternately in the longitudinal direction, the inner plates having two inner overlap regions facing the inside of the chain and the outer plates having two outer overlap regions facing away from the inside of the chain, the one plate of in each case two plates adjacent in the longitudinal direction in the plate string overlapping with one of its overlap regions over a correspondingly complementary overlap region of the other plate, the two plates being in each case connected together in articulated manner in a plane so as to be swivelable about a swivel axis and, to limit the swivel angle, stop projections being provided in the overlap region of the one plate and engaging in corresponding stop pockets provided in the overlap region of the other plate and embodied as depressions open to the other plate on only one side, stop faces of one stop projection interacting with mating stop faces of a stop pocket to limit the swivel angle, wherein:
each of the two overlap regions of the one plate comprises three, in particular precisely three, stop projections formed in one piece with this plate, wherein the three stop projections have a blocking width between their stop faces with an angular dimension of the blocking width, wherein the angular dimension of the blocking width preferably amounts in each case to at least 40° (α≥40°);
each of the two overlap regions of the other plate comprises three, in particular precisely three, stop pockets formed as depressions open on one side in this plate, wherein the three stop pockets have an opening width between their mating stop faces with an angular dimension of the opening width, wherein the angular dimension of the opening width preferably amounts in each case to at least 550 (β≥55°); and
the angular dimension of the blocking width of a stop projection amounts to at least 50% of the angular dimension of the opening width of a stop pocket.

25. An energy guide chain for guiding lines, such as hoses, cables or the like, between two connection points, with chain links which in each case comprise two opposing plates, of plastics material, the plates being connected together, in the case of at least some of the chain links, by way of at least one crosspiece, the energy guide chain having two plate strings in each case with inner plates of plastics material and outer plates of plastics material succeeding one another alternately in the longitudinal direction, the inner plates having two inner overlap regions facing the inside of the chain and the outer plates having two outer overlap regions facing away from the inside of the chain, the one plate of in each case two plates adjacent in the longitudinal direction in the plate string overlapping with one of its overlap regions over a correspondingly complementary overlap region of the other plate, the two plates being in each case connected together in articulated manner in a plane so as to be swivelable about a swivel axis and, to limit the swivel angle, stop projections being provided in the overlap region of the one plate and engaging in corresponding stop pockets provided in the overlap region of the other plate and embodied as depressions open to the other plate on only one side, stop faces of one stop projection interacting with mating stop faces of a stop pocket to limit the swivel angle, wherein:
each of the two overlap regions of the one plate comprises three, in particular precisely three, stop projections formed in one piece with this plate, wherein the three stop projections have a blocking width between their stop faces with an angular dimension of the blocking width;
each of the two overlap regions of the other plate comprises three, in particular precisely three, stop pockets formed as depressions open on one side in this plate, wherein the three stop pockets have an opening width between their mating stop faces with an angular dimension of the opening width; and
in at least one longitudinal portion of the energy guide chain, the angular dimension of the blocking width of the stop projections on the one plate, preferably on the outer plates, is selected such that these one plates, preferably outer plates, are swivelable relative to an extended position, both in one swivel direction and in an opposing, reverse swivel direction relative to the other plates, preferably inner plates, connected therewith about the respective swivel axis.

26. The energy guide chain according to claim 24, wherein the plate width of the plate string amounts, when measured in a direction parallel to the swivel axis, in each case to at most 25 mm, preferably ≤20 mm, particularly preferably ≤16 mm, wherein the ratio of plate width to outer height amounts in each case to ≤20%, particularly preferably ≤18%.

27. The energy guide chain according to claim 24, wherein:
the stop projections and the stop pockets, when viewed in the longitudinal section of the plates perpendicular to the swivel axis, have a contour which corresponds in each case substantially to a circular ring segment; and/or
the stop faces of the stop projections and the mating stop faces of the stop pockets form predominantly planar faces which lie substantially perpendicular to the swivel plane; and/or
the stop projections of the one plate have a mutually substantially identical angular dimension of the blocking width between their stop faces and the stop pockets of the other plate have a mutually substantially identical angular dimension of the opening width between their mating stop faces.

28. The energy guide chain according to claim 24, wherein:
the stop projections and the stop pockets are provided rotationally symmetrically or uniformly distributed in the circumferential direction about the respective swivel axis, preferably with 120° rotational symmetry relative to the swivel axis; and/or
to limit the swivel angle in each case one limit stop arrangement with precisely three stop projections is provided in each overlap region of the one plate, and to limit the swivel angle in each case one limit stop arrangement with precisely three corresponding stop pockets is provided in each overlap region of the other plate, wherein in each case precisely one stop projection engages in precisely one corresponding stop pocket.

29. The energy guide chain according to claim 24, wherein the outer plates in each case have a limit stop arrangement with precisely three stop projections in each of their outer overlap regions and the outer plates are of substantially mirror-symmetrical construction relative to a first plane of symmetry running in the longitudinal direction and through both swivel axes.

30. The energy guide chain according to claim 29, wherein the outer plate has a stop projection lying in the first plane of symmetry, which stop projection faces the central region, in the longitudinal direction, of the outer plate or faces away from the central region, in the longitudinal direction, of the outer plate.

31. The energy guide chain according to claim 27, wherein the stop faces and the mating stop faces form at least predominantly planar faces, wherein the two stop faces of a stop projection and/or the two mating stop faces of a stop pocket in each case intersect in a notional vertex axis which lies within the overlap region, preferably within a region through a notional incircle which lies radially to the inside of a or the circular ring segment contour of the stop pockets.

32. The energy guide chain according to claim 31, wherein the two mating stop faces of a stop pocket intersect in each case in a notional vertex axis lying within a region of a circular ring-shaped joint projection serving as a joint pin or a circular ring-shaped depression serving as a joint receptacle for receiving a corresponding joint projection of the opposing plate.

33. The energy guide chain according to claim 24, wherein the plate, preferably inner plate, form in each case an outwardly widening material bridge which is preferably substantially V-shaped in longitudinal section between two stop pockets succeeding one another in the circumferential direction about the swivel axis, which bridge has a minimum arc dimension at its narrowest point of ≥3 mm, in particular ≥4 mm, wherein the plate preferably forms a peripheral reinforcing ring into which the material bridges transition.

34. The energy guide chain according to claim 33, wherein the inner plate has a radially inner joint ring and, between joint ring and reinforcing ring, a circular ring-shaped depression serving as a joint receptacle for receiving a corresponding joint projection of the opposing plate, and the outer plate has a circular ring-shaped joint projection serving as joint pin, for interaction with the joint receptacle of the inner plate, wherein joint projection of the outer plate and stop projections of the outer plate preferably protrude inward by a substantially identical amount and end flush in a plane parallel to the swivel plane.

35. The energy guide chain according to claim 24, wherein stop pockets have an opening height radial to the swivel axis which amounts to at least 15%, preferably at least 20%, of the total height of the plate perpendicular to the longitudinal direction, wherein the stop projections have a corresponding radial dimension radial to the swivel axis reduced only by movement clearance.

36. The energy guide chain according to claim 24, wherein the energy guide chain comprises at least two longitudinal portions, with a first longitudinal portion, in which the energy guide chain does not have a reverse bend radius and a first type of plates, preferably a first type of outer plates, is provided with a first, larger angular dimension of the blocking width of the stop projections, and with a second longitudinal portion, in which the energy guide chain has a reverse bend radius and a second type of plates, preferably a second type of outer plates, is provided with a second, smaller angular dimension of the blocking width of the stop projections, wherein the second angular dimension is markedly smaller than the first angular dimension, such that the second type of plates, preferably the outer plates, are swivelable additionally in an opposing reverse swivel direction relative to the other plates of the first type.

37. The energy guide chain according to claim 24, wherein two holding projections are in each case provided in one piece on a central region of a plate, in particular of the inner plate, said holding projections projecting over an associated space into which in each case an adjacent further plate, in particular outer plate, may engage for lateral stabilization with a circular arc-shaped guide region extending parallel to the swivel plane.

38. The energy guide chain according to claim 24, wherein at least one stop projection has a radially protruding holding element and at least one corresponding stop pocket has a radially protruding retaining element, wherein holding element and retaining element interact in such a way as to hold connected plates laterally against one another.

39. The energy guide chain according to claim 34, wherein the outer plate has a thinner material thickness in tapered regions at longitudinal ends of the overlap region relative to its plate width than in its central region therebetween, wherein a region of greater material thickness relative to the tapered regions extends in the longitudinal direction preferably over at least 80% of the chain pitch and/or covers in particular at least 25% of the diameter of the circular ring-shaped joint pin or joint projection.

40. A side plate pair for an energy guide chain, comprising a plate, in particular an outer plate, and another plate, in particular an inner plate, in each case with the features according to claim 24.

41. Use of an energy guide chain according to claim 24 for circular movement.

42. Use of an energy guide chain according to claim 25, for vertical movement with a plurality of first length portions which can be positioned above one another in a zig-zag shape, wherein these are connected by way of second portions with a reverse bend radius.

43. An energy guide chain for guiding lines, such as hoses, cables or the like, between two connection points, with chain links which in each case comprise two opposing plates, of plastics material, the plates being connected together, in the case of at least some of the chain links, by way of at least one crosspiece, the energy guide chain having two plate strings in each case with inner plates of plastics material and outer plates of plastics material succeeding one another alternately in the longitudinal direction, the inner plates having two inner overlap regions facing the inside of the chain and the outer plates having two outer overlap regions facing away from the inside of the chain, the one plate of in each case two plates adjacent in the longitudinal direction in the plate string overlapping with one of its overlap regions over a correspondingly complementary overlap region of the other plate, the two plates being in each case connected together in articulated manner in a plane so as to be swivelable about a swivel axis and, to limit the swivel angle, stop projections being provided in the overlap region of the one plate and engaging in corresponding stop pockets provided in the overlap region of the other plate and embodied as depressions open to the other plate on only one side, wherein:
at least one stop projection has a radially protruding holding element and at least one corresponding stop pocket has a radially protruding retaining element, wherein holding element and retaining element interact in such a way as to hold connected plates laterally against one another.

44. The energy guide chain according to claim 38, wherein precisely two stop projections in each case have a radially protruding holding element and the corresponding two stop pockets have a radially protruding, interacting retaining element.

45. The energy guide chain according to claim 38, wherein each holding element and each retaining element:
is in each case provided on the radially outer circumferential region of the stop projection or of the stop pocket; and/or
extends circumferentially or in arcuate manner; and/or
is embodied as a radially protruding latching lug, in particular with an insertion bevel oblique relative to the swivel plane and a latching surface parallel to the swivel plane, and preferably is detachably latchable together with the in each case interacting element when the plates are joined together.

46. The energy guide chain according to claim 38, wherein:
two holding elements on stop projections of the outer plate are provided symmetrically relative to a longitudinal central plane, and two retaining elements are provided asymmetrically relative to a longitudinal central plane in corresponding stop pockets of the inner plate; and/or
two retaining elements are angularly offset in corresponding stop pockets in respect of swivel axis and/or are provided with different angular dimensions about the swivel axis, preferably such that they hold connected plates laterally against one another at least over a major proportion of the swivel axis.
